(19) United States
(12) Patent Application Publication
(10) Pub. No.: US 2026/0166836 A1
(43) Pub. Date: Jun. 18, 2026

(54) METHOD FOR MANUFACTURING A PATCHING SHEET AND A CARDBOARD PROCESSING SYSTEM

(71) Applicant: BOBST MEX SA, Mex (CH)

(72) Inventor: Alexandre DE KALBERMATTEN, Tartegnin (CH)

(73) Assignee: BOBST MEX SA, Mex (CH)

(21) Appl. No.: 19/422,883

(22) Filed: Dec. 17, 2025

(30) Foreign Application Priority Data
Dec. 18, 2024 (EP) 24221138.1

(51) Int. Cl. B31B 50/00; B31B 50/14

(52) U.S. Cl. CPC B31B 50/006; B31B 50/142

(57) ABSTRACT

A method for manufacturing a patching sheet for a pressing station of a cardboard processing machine, the method comprising the following steps:
obtaining a job recipe, the job recipe defining a model layout of cuts to be applied in a blank being cut in the cardboard processing machine;
cutting a sheet of blanks in the pressing station of the cardboard processing machine according to the model layout to obtain a trial sheet comprising cuts, each of the cuts in the trial sheet being associated to one of the cuts of the model layout;
measuring, by an imaging system, an image of the cuts in the trial sheet; the location of said cuts being defined by the model layout
computing, based on the measured image, the quality of each cut in the trial sheet to obtain a list of defective cuts needing correction;
determining, for each defective cut, a thickness of a patch to be applied on the patching sheet for correcting the defective cut to obtain a list of patches; and
building the patching sheet according to the list of patches.

Further, a cardboard processing system is provided.

### CROSS-REFERENCE TO RELATED APPLICATION(S)

This patent application claims the benefit of priority to European Application No. 24221138.1, filed on Dec. 18, 2024, the entirety of which is incorporated herein by reference.

### SUMMARY OF THE DISCLOSURE

The invention relates to a method for manufacturing a patching sheet for a pressing station of a cardboard processing machine and a cardboard processing system.

The process of die-cutting and creasing is fundamental in the manufacturing of cardboard boxes and other packaging materials. Traditionally, this process involves using a die-cutting machine comprising a pressing station equipped with cutting knives and/or creasing rules arranged in a specific layout to cut and/or crease sheets of cardboard, which are known as sheet of ‘blanks’. The blanks are the pre-cut boxes ready to be folded and glued and are extracted from the sheet of blanks after cutting. However, achieving precise cuts and/or creases in the order of tens of micrometers can be challenging due to variations in material properties, machine settings, wear of the knives, creasing rules and/or other parts of the die-cutting machine and other factors which lead to unevenness in the pressing station. As a result, operators often need to perform a process known as ‘patching’ to correct any defects in the cuts and/or creases.

Patching involves manually adding adhesive strips, also called ‘patches’, of varying thicknesses to specific areas of the die-cutting tool by preparing a patching sheet which is then placed in the pressing station to compensate for any deficiencies. The patches locally increase the thickness of the setup and thus compensate for the unevenness in the pressing station. This manual process is time-consuming, creates waste, requires highly skilled labor, and is prone to human error, which can lead to inconsistencies in the final product quality.

It is thus an object of the present invention to provide an optimized solution for automating the process of providing a patching sheet as much as possible.

This object is achieved by a method for manufacturing a patching sheet for a pressing station of a cardboard processing machine, the method comprising the following steps:

First, a job recipe is obtained, which defines a model layout of cuts to be applied to a sheet in the cardboard processing machine, creating a sheet of blanks. Next, the blanks are cut in the pressing station according to this model layout, resulting in a trial sheet with cuts corresponding to those in the model layout. An imaging system then records an image of the cuts in the trial sheet, with their locations defined by the model layout. Based on this image, the quality of each cut is assessed to identify defective cuts that need correction. For each defective cut, the method determines the thickness of a patch to be applied to the patching sheet and generates a list of patches. Finally, the patching sheet is constructed according to this list of patches.

The invention is based on the idea to automate the process of patching by preparing an image of the trial sheet and determining the patches which need to be applied on the patching sheet by checking the quality of the cuts. The model layout is used to determine where the cuts are located on the sheet of blanks. The resulting list of patches can then be applied onto the patching sheet in a fully or partially automated fashion such that also no personnel is required for building the patching sheet or less experienced personnel can reliably build the patching sheet.

The cardboard processing machine especially is a die-cutting machine and the pressing station especially is a die-cutting station.

The job recipe can be configured by an operator, or can be loaded from a local recipe repository or from a recipe repository stored in a cloud computing unit like a cloud server. By loading the job recipe from a local or cloud-based repository, the method can be further automated.

Of course, if need be, a job recipe loaded from such a repository can further be adapted by an operator in view of a desired model layout.

The term ‘defective cut’ denotes a cut which does not correspond to the desired cut defined by the model layout of cuts. The defective cut can be defective over the full length of the defective cut according to the model layout or can also be a defective cut section of the respective cut.

The imaging system can be integrated in the cardboard processing machine or can be an external device. By integrating the imaging system in the cardboard processing machine, the manufacturing process of the patching sheet can be more easily further automated, while an external imaging system increases the flexibility in using the imaging system. E.g., the same imaging system might be used in combination with a plurality of cardboard processing machines.

In one variant, the imaging system comprises a backlight imaging unit comprising a backlight and a camera being configured to measure an intensity of light being emitted by the backlight, and the trial sheet is placed between the camera and the backlight to measure the image of the cuts. Thus, the image obtained in the imaging system contains backlight intensity information for all of the cuts in the trial sheet. Based on the backlight intensity information, defective cuts can be identified while the overall set-up of the imaging system can be simple and cost-efficient.

The backlight can comprise a plurality of light emitting elements configured for emitting light onto the trial sheet and/or the camera can comprise a plurality of sensor elements configured for measuring an intensity of the light being emitted by the backlight after being influenced by interaction with the trial sheet. Especially, each light emitting element of the backlight has at least one associated sensor element of the camera.

To further improve the contrast in the image comprising backlight intensity information, the backlight can be arranged on a front side of the cuts, and the camera can be arranged on a back side of the cuts.

The ‘front side’ is defined as the side into which cutting tools of the pressing station penetrate into the blank, while the ‘back side’ is the side of the cut being opposite thereto.

The expression ‘placed between’ the camera and the backlight also includes that the trial sheet can be moved through between the camera and the backlight, i.e. the trial sheet does not need to be in a fixed position while the image is taken.

To minimize the space requirements of the imaging system, the camera can be a line camera and the image is measured by obtaining a plurality of one-dimensional imaging data being combined to form the image. That is, the trial sheet is moved through between the line camera and the backlight, thereby obtaining the plurality of one-dimensional imaging data from which the overall image is then reconstructed.

In another variant, the imaging system comprises a 3D scanning unit and the image is measured as a 3D profile of the trial sheet. The three-dimensional information about the trial sheet allows to obtain an precise image containing the required information about the presence and quality of the cuts in the trial sheet.

To further improve the quality of the image obtained by the imaging system, a structured light pattern can be projected by at least one light source of the 3D scanning unit on the trial sheet and can be measured after interaction with the trial sheet by at least two cameras of the 3D scanning unit.

The structured light pattern can comprise a pseudo-random pattern or a set of parallel lines, especially equidistant parallel lines. Corresponding light sources for 3D scanning units are commercially available and provide a reliable structured light pattern, thereby further improving the quality of the measured image.

The 3D profile can be determined by triangulation based on the individual camera images measured by the at least two cameras of the 3D scanning unit.

The structured light pattern can be projected on the front side of the trial sheet or on the back side of the trial sheet. If the front side is used, the 3D profile corresponds to a measurement of the groove depth of the cuts. If the back side is used, the 3D profile corresponds to a measurement of the bump height of the cuts.

To avoid or at least minimize the size of shaded areas in the image measured by the 3D scanning unit, the structured light pattern can be projected onto the trial sheet by at least two different light sources of the 3D scanning unit from different directions.

The at least two different light sources can use the same structured light pattern or different structure light patterns.

It is also possible that several 3D profiles of the trial sheet are measured one after each other, with different 3D profiles obtained by projecting a structured light pattern from different light sources. In this way, interference of the structured light patterns from different light sources can be minimized and evaluation of the data obtained by the at least two cameras of the 3D scanning unit is simplified.

To further increase the reliability of identifying defective cuts in the trial sheet, computing the quality of each cut in the trial sheet whose position is defined in the model layout can comprise aligning the measured image of the cuts in the trial sheet with the model layout of cuts. In this way, errors emanating e.g. from unwanted rotations or shifts of the trial sheet during measurement by the imaging system can be compensated for.

Aligning the measured image of the cuts in the trial sheet with the model layout of cuts can be based on a 2D motion model including translation, rotation and/or scale parameters.

Computing the quality of each of the cuts in the trial sheet comprises computing a score that represents the quality of the respective cut, and comparing the score with a threshold value is indicative of whether a cut is defective or not defective.

If a backlight imaging unit is used, the score can be calculated based on the intensity and the intensity spread of at the respective cut. If a 3D scanning unit is used, the score can be calculated based on the depth or height and the depth spread or height spread at the respective cut. The ‘spread’ here denotes the lateral extension of the respective cut, especially in a direction perpendicular to the extension direction of the respective cut.

For further improving the resolution in determining the quality of the cuts, the score can be calculated individually for each pixel in the image representing a part of the respective cut.

The threshold value can be a pre-defined threshold value or can be calculated based on the measurement data. E.g., a median value of individual pixels in the image representing the cut can be calculated and the threshold value can be based on a deviation from said median value.

Computing the quality of the cut in the trial sheet further may comprise aggregating the scores into the list of defective cuts, the list of defective cuts including the scores, a position and a length of segments of the defective cuts needing correction. In this way, in addition to the thickness of the patches to be applied on the patching sheet, the list of defective cuts further provides information on where the patches are to be applied and how large they should be along the paper plane of the patching sheet.

The score can be calculated on a cloud computing unit being configured for bi-directional data communication with the imaging system and/or the cardboard processing machine. This allows to further automate the manufacturing process of the patching sheet, as the score is obtained in the cloud computing unit. Further, the computing capabilities of the imaging system and/or of the cardboard processing machine can be lowered, as the complex calculation of the score can be realized in the external cloud computing unit like a cloud server.

The data obtained in the imaging unit can be sent to and received by the cloud computing unit such that the cloud computing unit has the data available necessary to calculate the score.

Of course, in general, it is also possible that the score is calculated on a local computing unit of the imaging system and/or of the cardboard processing machine.

It is also possible that the cloud computing unit is used in or for further steps of the method for manufacturing the patching sheet. E.g., the same cloud computing unit may provide the job repository from which the job recipe is obtained, i.e. the job recipe defining the model layout of cuts can be sent by the cloud computing unit and received by the cardboard processing machine.

Determining, for each defective cut, a thickness of a patch to be applied on the patching sheet can be based on the scores, the length of the segments or a combination of both. That is, the thickness of each patch which is to be applied on the patching sheet can be combined with further information on the cut to obtain an optimal patching scheme.

In one variant, building the patching sheet comprises (i) placing a patching sheet precursor on a table of a digital inspection assembly, (ii) projecting, by a projection device of the digital inspection assembly, an image of each patch from the list of patches on the patching sheet precursor including an indicator representative for the thickness of the respective patch, and (iii) attaching, for each image, a physical patching strip corresponding to the indicator on the patching sheet precursor.

The indicator can be a colour, a numeric representation of the thickness, a name or a combination thereof. E.g., the indicator may be a colour which allows for an especially easy identification of the type and size of the physical patching strip(s) to be applied on the patching sheet precursor.

The colour(s) used as indicator can correspond to colour(s) used to colour-code different thickness values of commercially available patching tapes. In this way, errors in applying the correct patching strip can be further minimized.

Attaching the physical patching strip(s) can be done by an operator or by a robot.

Since the indicator shows where each type of physical patching strip should be applied on the patching sheet precursor, it becomes particularly easy to replicate the pattern on the patching sheet precursor. This simplifies the process of applying the correct type of patching strip in the desired locations, enabling less experienced personnel to operate and construct the patching sheet with high accuracy and speed.

Alternatively, the process of manufacturing the patching sheet can be further automated by applying the patching strips by a robot which is configured to detect the image of each patch including the associated indicator and to attach the physical patching strip according to the associated indicator.

In another variant, building the patching sheet comprises (i) printing a patching sheet precursor, the printed patching sheet precursor comprising an image of each patch from the list of patches including an indicator representative for the thickness of the respective patch, and (ii) attaching, for each image, a physical patching strip corresponding to the indicator on the patching sheet precursor. In this variant, the complexity of devices needed for building the patching sheet can be reduced, as only a printer configured for printing the patching sheet precursor has to be provided. Also, the print may include the complete cut and crease layout, thereby helping clarify the relation between the tools carrying the knives and the patching sheet, reducing the risk of either using the wrong patching sheet for a given cutting tool and reducing the risk to install the patching sheet upside down.

In yet another variant, building the patching sheet comprises (i) placing a patching sheet precursor on a table of an additive manufacturing printing assembly, and (ii) printing the patches on the patching sheet precursor according to the list of patches by an additive manufacturing technique. This allows to further automate the manufacturing process, as the additive manufacturing printing assembly can operate with as less interaction with an operator as possible. Furthermore, precision of the applied patches can be further improved and also unusual sizes of patches can easily be reproduced on the patching sheet precursor by three-dimensional printing which can be realized by additive manufacturing techniques.

The object of the invention is further solved by a cardboard processing system comprising a cardboard processing machine with a pressing station for cutting sheets of blanks, the cardboard processing system being configured to perform the method of any of the preceding claims.

The features and advantages of the method for manufacturing a patching sheet according to the invention apply for the cardboard processing system, according to the invention too, and vice versa, and it is referred to the explanations given above.

The cardboard processing machine especially is a die-cutting machine and the pressing station especially is a die-cutting station.

The cardboard processing system can comprise a job recipe management system, which is configured to obtain a model layout of cuts to be applied in the pressing station in a blank based on a job recipe.

The job recipe can be stored locally in the cardboard processing system, e.g. in the job recipe management system itself, or in a cloud computing system which is configured for bi-directional data communication with the cardboard processing machine.

The cardboard processing system may further comprise an imaging system for measuring an image of cuts applied in blanks being processed by the cardboard processing machine.

The imaging system may be integrated in the cardboard processing machine or may be a separate device.

The cardboard processing system can further include a patching determination system configured to determine a thickness of a patch to be applied on a patching sheet for correcting for defective cuts in the trial sheet.

In one variant, the cardboard processing system comprises a digital inspection assembly which is configured to project an image of one or more patches onto a patching sheet precursor.

In a further variant, the cardboard processing system comprises an additive manufacturing assembly being configured for printing patches on a patching sheet precursor by an additive manufacturing technique.

### BRIEF DESCRIPTION OF THE DRAWINGS

Further features and properties of the invention become more apparent from the following description of exemplary embodiments, which are not to be understood as limiting, and the appended Figures. In the Figures:

FIG. 1 shows a cardboard processing system according to the invention;

FIG. 2 shows a model layout of cuts and creases to be applied in a blank in the cardboard processing system of FIG. 1;

FIG. 3 shows selected parts of an imaging system of the cardboard processing system of FIG. 1;

FIG. 4 shows parts of an exemplary image obtained by an imaging system of FIG. 3;

FIG. 5 shows a variant of the imaging system of FIG. 3;

FIG. 6 shows a patching sheet for the cardboard processing system of FIG. 1;

FIG. 7 shows a digital inspection assembly of the cardboard processing system of FIG. 1; and

FIG. 8 shows a block scheme of a method for manufacturing a patching sheet according to the invention;

FIG. 9 shows an image of a cut's groove;

FIG. 10 shows two images of a cut's groove, one of a good cut, and one of a defective cut;

FIG. 11 shows a section of a light ray of a cut.

### DETAILED DESCRIPTION OF EMBODIMENTS

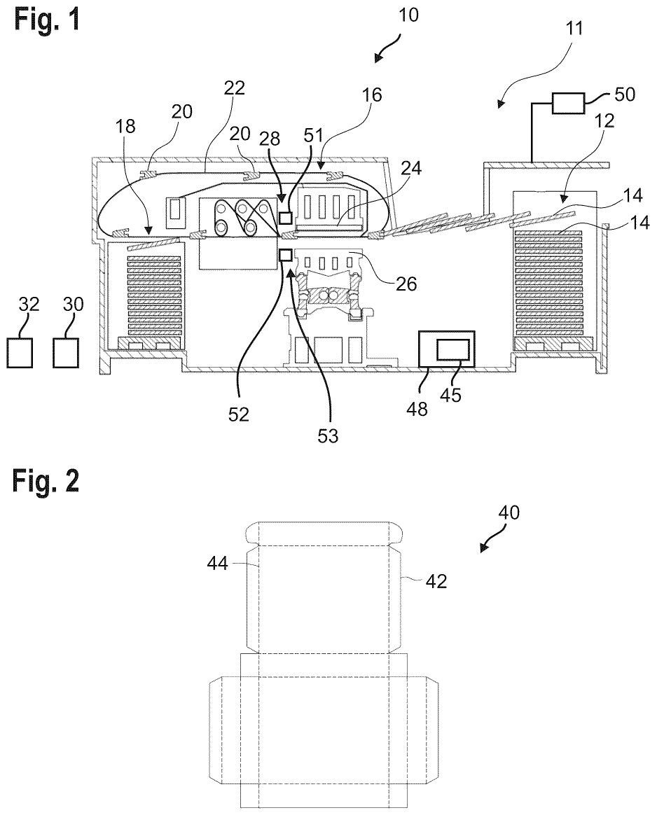

FIG. 1 shows a cardboard processing system 10 comprising a cardboard processing machine 11, in particular a die-cutting machine.

The cardboard processing machine 11 comprises a feeding station 12 in which cardboard blanks 14, in the following also referred to as ‘blanks’14, to be processed are piled.

Further, the cardboard processing machine 11 comprises a pressing station 16 in which the blanks 14 are cut and optionally creased. Thus, the cardboard processing machine 11 can also be a combined die-cutting and creasing machine.

In a piling station 18, the cardboard blanks 14 can be piled before they are withdrawn from the cardboard processing machine 11.

The cardboard blanks 14 can be moved along a processing direction by means of gripper bars 20, which are attached to a drive chain 22.

Pressing station 16 comprises an upper platen 24 and a lower platen 26. The upper platen 24 is arranged above the lower platen 26. The platens 24, 26 are moveable towards each other to cut, and optionally crease, a blank 14 positioned between the platens 24 and 26. In the exemplary embodiment, the upper platen 24 is fixed and the lower platen 26 is moveable.

To cut or to cut and crease the blanks 14, a tooling plate carrying knives for cutting the blanks 14 and optionally carrying creasing rules for creasing the blanks 14 may be attached to the upper platen 24 or the lower platen 26.

To the other platen 24 and 26, an optional tooling plate with slots or grooves corresponding to the knives and/or creasing rules is attached.

The tooling plates are exchangeable since different tooling plates are necessary for different production jobs.

The cardboard processing machine 11 further comprises an imaging system 28 which will be explained in more detail later on.

In the embodiment shown in FIG. 1, the imaging system 28 is integrated in the cardboard processing machine 11. However, it is also possible that the imaging system 28 is a separate device of the cardboard processing system 10.

The cardboard processing system 10 further comprises a digital inspection assembly 30 and an additive manufacturing printing assembly 32.

Coming back to the pressing station 16, the pressure applied by the platen 24 and 26 to the blank 14 must be as uniform as possible to achieve a high quality of the cutting and/or creasing process in the pressing station 16. To ensure an accurate cut and/or crease, the accuracy of a distance between the platens 24 and 26 during a pressing process needs to be in the range of a few tens of micrometers.

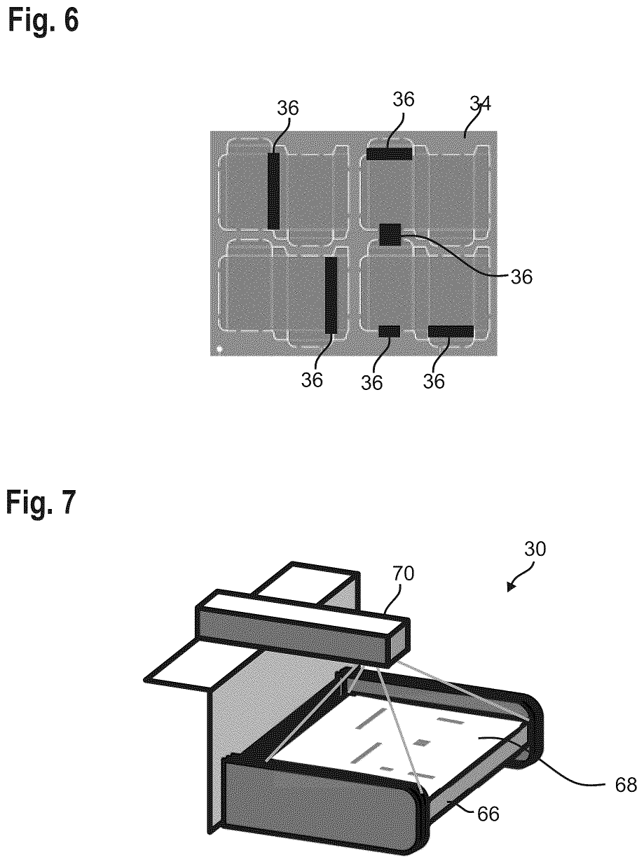

However, due to variations in material properties, machine settings, wear of the knives or creasing rules and/or other parts of the pressing station 16, possible unevenness between the upper platen 24 and the lower platen 26 needs to be compensated. For this purpose, it is known to introduce a patching sheet 34 into one of the platen 24 and 26, the patching sheet 34 comprising patches 36 which locally increase the thickness such to compensate for insufficient contact between the knives and/or creasing rules and the blank 14 (see FIG. 6).

The cardboard processing system 10 is configured to perform a method for manufacturing a patching sheet 34 for the pressing station 16 of the processing machine 11, which will be explained in the following.

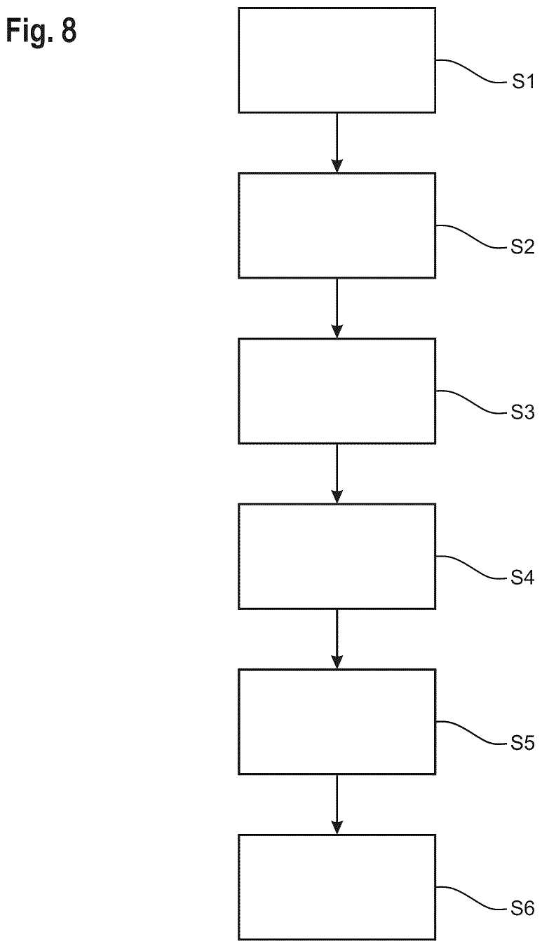

First, a job recipe is obtained, wherein the job recipe defines a model layout 40 of cuts to be applied in the blank 14, when the blank is cut in the cardboard processing machine 11 (see step 1 in FIG. 8).

An example of a model layout 40 is shown in FIG. 2, wherein full lines in FIG. 2 depict location of cuts 42 to be applied in the blank 14 and dashed lines depict the location of creases 44 to be applied in the blank 14.

Thus, in addition to the cuts 42 being defined by the job recipe, the job recipe can also include additional information like a model layout of creases. It is also possible that the job recipe contains information like the type and/or size of the blanks 14, the number of model layouts 40 to be applied per blank 14 and/or recommend machine settings for the cardboard processing machine 11 like the pressure applied by the platen 24 and 26.

In the example shown in FIG. 2, the model layout 40 defines a cardboard box which can be formed after extracting a respective box precursor from the processed blank 14, e.g. in a blanking operation. The box precursor is then folded along the creases 44 to form the cardboard box.

Of course, the model layout 40 shown in FIG. 2 is only an example and the method according to the invention is not limited to such kind of model layouts 40.

The job recipe can be obtained from a local recipe repository 45 stored in a local controlling and memory unit 48 or from a cloud computing unit 50 of the cardboard processing system 10, wherein the cloud computing unit 50 is configured for bi-directional communication with the cardboard processing machine 11.

The connection between the cloud computing unit 50 and the cardboard processing machine 11 can be a wired and/or a wireless connection.

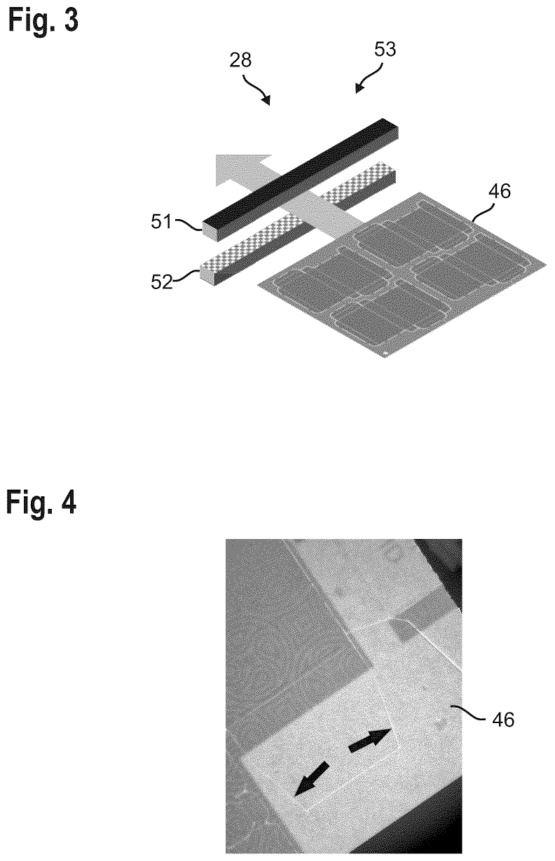

Based on the model layout 40, a blank 14 is cut in the pressing station 16 to obtain a trial sheet 46 (see FIG. 3 and step S2 in FIG. 8). The trial sheet 46 comprises cuts each of which correspond to one of the cuts 42 defined by the model layout 40.

Depending on how well the pressing station 16 of the cardboard processing machine 11 corresponds to the intended mode of action, the cuts in the trial sheet 46 will be of the desired quality or be of lower quality. E.g., a given cut in the trial sheet 46 might be too shallow to penetrate the trial sheet 46 as intended or only parts of a given cut in the trial sheet 46 actually penetrates the trial sheet 46.

Termed differently, the trial sheet 46 is a physical testing model for how uniform the pressing station 16 operates at the time the trial sheet 46 is produced, and therefore can serve as a basis for evaluating if a patching sheet 34 is needed to ensure a good quality of processed blanks 14 and what kind of patches 36 need to applied on said patching sheet 34.

According to the invention, the quality of the trial sheet 46 is assessed based on an image of the cuts in the trial sheet 46. For this purpose, an image of the cuts in the trial sheet 46 is measured by the imaging system 28 (see step S3 in FIG. 8).

For taking the image, the trial sheet 46 is moved along the processing direction of the cardboard processing machine 11 through the imaging system 28, more specifically between a backlight 51 and a camera 52 of an backlight imaging unit 53 of the imaging system 28 (see FIG. 3).

The backlight 51 is arranged above the trial sheet 46 and is associated with a front side of the cuts in the trial sheet 46, while the camera 52 is arranged below the trial sheet 46 and is associated with a back side of the cuts in the trial sheet 46.

In principle, the arrangement of the backlight 51 and the camera 52 relative to the trial sheet 46 can also be reversed.

The backlight 51 comprises a plurality of light emitting elements configured to emit light in the direction of the camera 52, and the camera 52 comprises a plurality of sensor elements configured to receive the light emitted by the plurality of light emitting elements and passing through the trial sheet 46.

The intensity of the light detected by the plurality of sensor elements of the camera 52 is attenuated depending on the thickness of the trial sheet 46 at a given location. Thus, the higher the intensity detected by the camera 52, the thinner the material of the trial sheet 46 such that a cut extending through the full thickness of the trial sheet 46 is associated with the highest intensity.

FIG. 4 shows a partial image of an exemplary trial sheet 46 obtained by an exemplary backlight imaging unit 52, in which two cuts are indicated with arrows.

Furthermore, the spread of the intensity along the cut in the trial sheet 46 is a further parameter that can be used to assess the quality of the cut. The reason behind is that light traversing the cardboard is scattered, resulting in a spread of light. The thicker the layer of cardboard that must be traversed by the light beam, the higher the spread (for a given cardboard). Thus, if the cardboard is not cut completely, light will spread more. Even in the case of a good cut, sometimes the fibers of the paper get back together after the cut, and thus result also in a spread. However, statistically, a good cut will result in a sharper light intensity profile..

As shown in FIG. 3, the camera 52 may be a line camera such that the image is measured by obtaining a plurality of one-dimensional imaging data measurements which are then combined to form the desired image. Accordingly, the backlight 51 only needs to extend over an area analog to the area covered by the line camera. Thus, the overall backlight lighting unit 53 has a compact design.

In the shown embodiment, the imaging system 28 is integrated in the cardboard processing machine 11 such that the image can be measured immediately after the trial sheet 46 has been prepared in the pressing station 16.

However, if the imaging system 28 can also be placed outside of the cardboard processing machine 11. In this case, the trial sheet 46 can be transported to the piling station 18, withdrawn from the cardboard processing machine 11 from the piling station 18 and inserted in the separate imaging system 28.

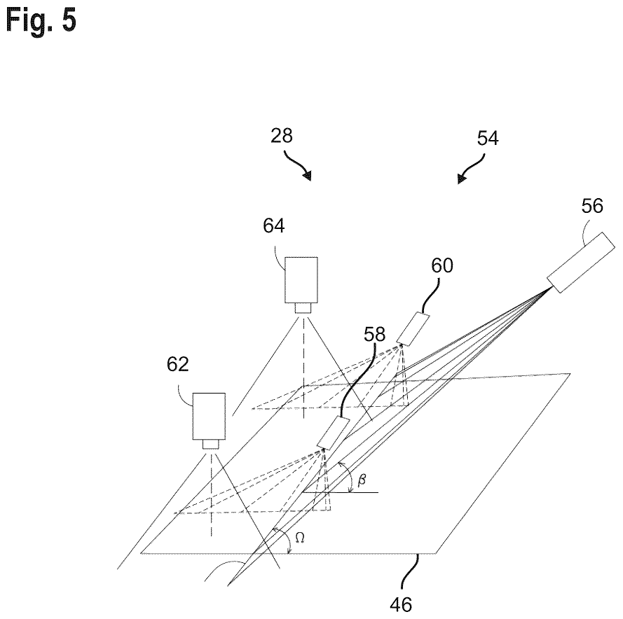

FIG. 5 depicts a variant of the imaging system 28.

In this variant, the imaging system 28 comprises a 3D scanning unit 54.

The 3D scanning unit 54 comprises a plurality of light sources 56, 58, and 60, each configured to project a structured light pattern onto the trial sheet 46.

The structured light pattern might be a pseudo-random pattern or a set of parallel lines, e.g. a set of blue equidistant parallel lines.

The light source 56 and the light sources 58 and 60 project their respective structured light pattern from different directions to avoid shadow areas in the images obtained from the 3D scanning unit 54.

Of course, the 3D scanning unit can comprise less or more light sources than shown in FIG. 5.

Each of the projected structural light patterns interacts with the trial sheet 46 and is at least partially reflected from the trial sheet 46. The reflected light is detected by at least two cameras 62 and 64 of the 3D scanning unit 54, which are spaced apart from each other along the trial sheet 46.

The individual images measured by the cameras 62 and 64 are different from each other based on the surface structure of the trial sheet 46. E.g., if the light sources 56, 58, and 60 illuminate the front side of the trial sheet 46, the images obtained by the cameras 62 and 64 will be influenced by groove depths formed by the cuts and/or creases in the trial sheet 46. If the light sources 56, 58 and 60 illuminate the back side of the trial sheet 46, the images obtained by the cameras 62 and 64 will be influenced by bump heights formed by the cuts and/or creases in the trial sheet 46.

From the images, the type of structured light used, the positions of the light sources 56, 58 and 60 and the positions of the cameras 62 and 64, the image of the trial sheet 46 can be reconstructed, e.g. by triangulation. This reconstruction can be done on a computing unit of the imaging system 28 itself, in the local controlling and memory unit 48 or in the cloud computing unit 50.

Based on the image measured in the imaging system 28, each cut 42 in the model layout 40 is compared with the associated cut in the trial sheet 46 (see step S4 in FIG. 8).

The computation of the quality of the cuts can first include aligning the measured image of the cuts in the trial sheet 46 with the model layout of cuts, e.g. based on a two-dimensional motion model based on which the measured image can be compensated for errors emanating from a translated or rotated trial sheet 46 when measuring the image. The model layout is used to determine, for every position on the trial sheet 46, if there should be a cut, a crease or nothing.

Further, the computation of the quality of the cuts can include calculating, for each of the cuts in the trial sheet 46, a score that represents the quality of the respective cut, and comparing the score with a threshold value being indicative for whether a cut is defective or not defective.

The threshold can be a pre-defined threshold value or can be calculated based on a median value of individual pixels in the image representing a respective cut.

Unfortunately, in practice, there are sometimes good cuts that appear as bad ones. To reduce the consequence of this phenomenon, along each cut, we may apply a spatial filtering along each cut, which consists in retaining the best score in the vicinity of the cut. In practice, for each location where we assign a score, we retain the best score computed in a vicinity of plus or minus 1 mm from said location. By vicinity, we mean the location along the cut line, the direction of which is defined by the model layout 40.

Based on the aggregation of the scores along the cut lines, a list of defective cuts is obtained, wherein said list denotes each of the cuts in the trial sheet 46 which does not completely cross the thickness of the cardboard.

There are several ways to compute the score. The score may even be considered first as a multi-dimensional score, which is then reduced to a single score. The score may be computed from the depth of the cut 100, the width of the cut's groove 102,104, the intensity of the light 106 emitted by the backlight and recorded by the camera, or the spread 108 of said light.

To compute the spread of the light 108, we may, for example, first compute the set of all the intensities along the cut lines and take the median of these intensities as a reference intensity 110. Then, we take a fraction of said reference intensity 112, for example 80% of said intensity, and use the resulting value as a reference for computing the spread. The spread can be computed as the width of the section of the light ray 114 whose intensity is larger than said value, measured across the cutline, i.e. measured along a direction which is perpendicular to the cut line, as shown in FIG. 11.

To compute the width of the cut's groove 102,104, we consider the section of the groove 120,121,122, i.e. the height of the cardboard surface measured along a perpendicular of the cut, and measure the width of the cut's groove 102,104 from at a fixed depth 118 from the cardboard surface. Good cuts tend to have grooves 121 with a larger width 102 than bad ones since bad cuts still have some cardboard fibres that keep the cardboard together, as shown in FIG. 10.

To compute the intensity of the light 106, we retain the maximum intensity of the light beam 114 that crosses the cardboard. Thus, at each location along the cut line 42, we retain the maximum of the light intensity profile measured across the cut line 42, thus measured along the perpendicular to the cut line 42.

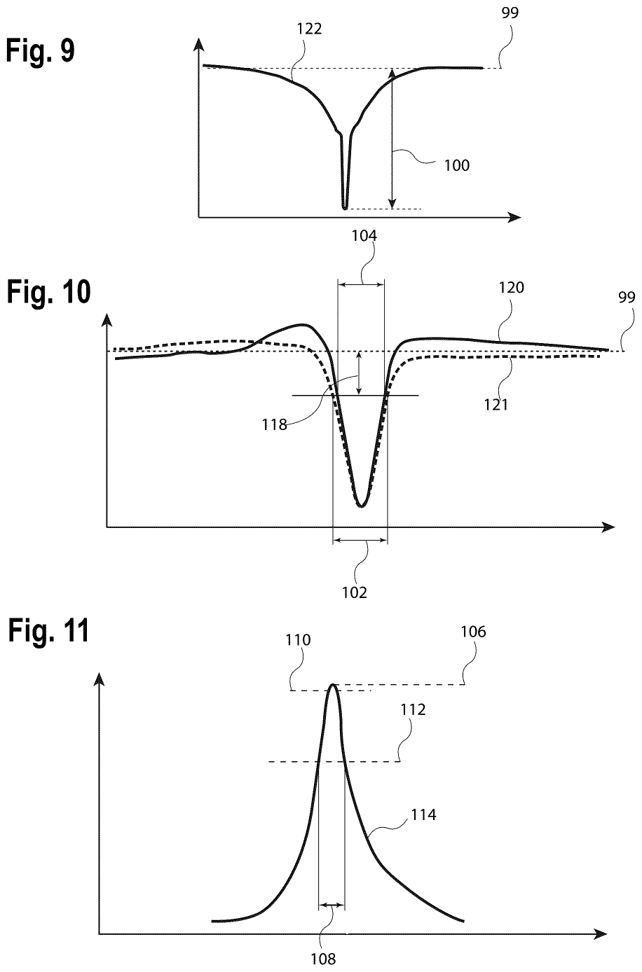

To compute the depth of the cut 100, we measure the depth profile of the groove 120, 121, 122 created by the cut, and retain the difference in height between the cardboard surface 99 and the deepest point of the groove, as shown in FIG. 9.

From these raw measurements, (i.e. the depth of the cut 100, the width of the cut's groove 102,104, the intensity of the light 106 and the spread of said light 108), we compute the score as a percentage of the median value for each measurement type. The median is computed by collecting all the measurements of a type. For example, we can collect all the depth of the cuts along all the cutlines, compute the median, and compute the score in a given location as the depth of the cut line 42 divided by said median. This method is based on the assumption that at least half of the cuts are performed according to specification. Also, to compute the width of the cut's groove, we may set the depth 118 at which the measurement is taken based on the median of the depth of the cuts, or even based on the cardboard thickness.

To obtain the score of the cut, we may either choose a score based on one of the four types of measurement (i.e. the depth of the cut 100, the width of the cut's groove 102,104, the intensity of the light 106 and the spread of said light 108) or compute a score based on a combination of these four scores or a combination of a subset of these four scores.

We noticed that good cuts may appear as bad ones (i.e. low depth, or a spread equal to a bad cut), but the inverse is rarely true. For example, a bad cut will not have a depth equal to the cardboard thickness but will exhibit a lower value. Thus, in one embodiment, we combine the scores (at each location) as the best score among all the computed scores. For example, we may take the best score among the scores computed from the width of the cut's groove and from the depth of the cut.

The scores can also be aggregated (after spatial filtering) into the list of defective cuts such that further information about the defective cuts can be combined like the position and/or the length of segments of the defective cut which are of insufficient quality.

Then, for each defective cut, a thickness of a patch 36 to be applied on the patching sheet 34 for correcting the respective defective cut is calculated to obtain a list of patches (see step S5 in FIG. 8).

The thickness of the patch 36 can be based on the scores, the length of the segments of the respective defective cut or a combination of both. E.g., a lower score can indicate that a patch 36 of higher thickness is necessary for successful correction of the cut.

The computation of the quality of the cuts according to the model layout 40 and/or determining the thickness of the patches 36 can be done either in the cardboard processing machine 11 itself, e.g. in the local controlling and memory unit 48, or in the cloud computing unit 50. Relying on the cloud computing unit 50 has the advantage that the computing power of the cloud computing unit 50 can be designed independently from a given cardboard processing machine 11. E.g., the same cloud computing unit 50 can be used for a plurality of cardboard processing machines 11, which decreases the overall cost of the cardboard processing system 10 while achieving high accuracy in determining the list of patches in a short time.

Finally, the patching sheet 34 is built according to the list of patches, e.g. in the digital inspection assembly 30 or the additive manufacturing printing assembly 32.

FIG. 7 shows a variant of the digital inspection assembly 30, in which the digital inspection assembly 30 comprises a table 66 onto which a patching sheet precursor 68 is placed, and a projection device 70.

The patching sheet precursor 68 can be a sheet of paper on which the patches 36 need to be applied to form the desired patching sheet 34.

The projection device 70 is configured to project an image onto the patching sheet precursor 68 for each of the patches 36 from the list of patches, wherein the image is representative for the position and the size of the patch 36 to be applied.

The image also includes an indicator for the type of patch, e.g. a colour, a numeric representation of the necessary thickness, a name of the type of patch to be applied or a combination thereof.

Thus, an operator only needs to attach, for each image projected by the projection device 70, a corresponding physical patching strip to form the desired patches 36 on the patching sheet precursor 68 such to build the patching sheet 34.

It is also possible that instead of an operator, the physical patching strips are applied by a robot which is configured to detect the images projected onto the patching sheet precursor 68 by the projection device 70.

Alternatively, the patching sheet precursor 68 may be printed, with the printed patching sheet precursor 68 comprising an image of each patch from the list of patches including the indicator representative of the thickness of the respective patch. Then, an operator or a robot can apply the physical patching strips based on the images printed on the patching sheet precursor 68. In this way, it is not necessary to provide the digital inspection assembly 30 and/or the additive manufacturing printing assembly 32 in the cardboard processing system 10.

When the additive printing assembly 32 is to be used for building the patching sheet 34, the patching sheet precursor 68 is first placed on a table of the additive printing assembly 32 and the patches 36 are 3D-printed by an additive manufacturing technique onto the patching sheet precursor 68.

In the variant shown in FIG. 1, the cardboard processing system 10 comprises both a digital inspection assembly 30 and an additive manufacturing printing assembly 32, thereby offering greater flexibility in how the patching sheet 34 is built. However, the cardboard processing system 10 can also include only one of the digital inspection assembly 30 and the additive manufacturing printing assembly 32 or none of both in case another option is used to build the patching sheet 34.

Overall, the method for preparing the patching sheet 34 and the cardboard processing system 10 enables to further automate the process of manufacturing patching sheets 34 and reduce human error and downtimes of the cardboard processing machine 11.

1. A method for manufacturing a patching sheet for a pressing station of a cardboard processing machine, the method comprising:
obtaining a job recipe, the job recipe defining a model layout of cuts to be applied in a blank being cut in the cardboard processing machine;
cutting a blank in the pressing station of the cardboard processing machine according to the model layout to obtain a trial sheet comprising cuts, each of the cuts in the trial sheet being associated to one of the cuts of the model layout;
measuring, by an imaging system, an image of the cuts in the trial sheet; the location of said cuts being defined by the model layout;
computing, based on the measured image, the quality of each cut in the trial sheet to obtain a list of defective cuts needing correction;
determining, for each defective cut, the thickness of a patch to be applied on the patching sheet for correcting the defective cut to obtain a list of patches; and
building the patching sheet according to the list of patches.

2. The method according to claim 1, wherein the imaging system comprises a backlight imaging unit comprising a backlight and a camera being configured to measure an intensity of light being emitted by the backlight, and the trial sheet is placed between the camera and the backlight to measure the image of the cuts.

3. The method according to claim 2, wherein the backlight is arranged on a front side of the cuts, and the camera is arranged on a back side of the cuts.

4. The method according to claim 2, wherein the camera is a line camera and the image is measured by obtaining a plurality of one-dimensional imaging data being combined to form the image.

5. The method according to claim 2, wherein the imaging system comprises a 3D scanning unit and the image is measured as a 3D profile of the trial sheet.

6. The method according to claim 5, wherein a structured light pattern is projected by at least one light source of the 3D scanning unit onto the trial sheet and is measured after interaction with the trial sheet by at least two cameras of the 3D scanning unit.

7. The method according to claim 6, wherein the structured light pattern is projected onto the trial sheet by at least two different light sources of the 3D scanning unit from different directions.

8. The method according to claim 5, wherein computing the quality of each cut in the trial sheet comprises calculating, for each of the cuts in the trial sheet, a score at each location along cut lines that represents the quality of the respective cut line.

9. The method according to claim 8, wherein computing the quality of each cut in the trial sheet comprises computing a score at each location along a cut line and filtering each of said scores by retaining the best score in a neighbourhood of said location along said cut line.

10. The method according to claim 8, wherein the score is calculated based on the depth of the cut measured by the 3D scanning unit.

11. The method according to claim 8, wherein the score is calculated based on the angle of the groove of the cut measured by the 3D scanning unit.

12. The method according to claim 8, wherein the score is calculated based on the peak of the intensity of the light emitted by the backlight and measured by the camera.

13. The method according to claim 8, wherein the score is calculated based on a spread of the intensity of the light emitted by the backlight and measured by the camera.

14. The method according to claim 8, wherein the score is calculated, at each location of the cut line, as a combination of the depth of the cut and of the width of the cut's groove measured by the 3D scanning unit.

15. The method according to claim 8, wherein the score is compared to a threshold value, resulting in a thresholded score being indicative of whether a cut is defective or not defective.

16. The method according to claim 15, further comprises aggregating the thresholded scores into the list of defective cuts, the list of defective cuts including the scores, a position and a length of segments of the defective cuts needing correction.

17. The method according to claim 16, wherein determining, for each defective cut, a thickness of a patch to be applied on the patching sheet is based on the scores, the length of the segments or a combination of both.

18. The method according to claim 1, wherein building the patching sheet comprises placing a patching sheet precursor on a table of a digital inspection assembly, projecting, by a projection device of the digital inspection assembly, an image of each patch from the list of patches on the patching sheet precursor including an indicator representative for the thickness of the respective patch, and attaching, for each image, a physical patching strip corresponding to the indicator on the patching sheet precursor.

19. The method according to claim 1, wherein building the patching sheet comprises printing a patching sheet precursor, the printed patching sheet precursor comprising an image of each patch from the list of patches including an indicator representative for the thickness of the respective patch, and attaching, for each image, a physical patching strip corresponding to the indicator on the patching sheet precursor.

20. A cardboard processing system comprising the cardboard processing machine with the pressing station for cutting blanks, the cardboard processing system being configured to perform the method of claim 1.
